(19) United States
(12) Patent Application Publication
(10) Pub. No.: US 2013/0212035 A1
(43) Pub. Date: Aug. 15, 2013

(54) SCANNER ASSISTED UPLOAD AND ENCRYPTED DATA GENERATION DEVICE, SYSTEM, METHOD, AND COMPUTER READBLE MEDIUM

(71) Applicants: Cameron James LAIRD, Milton (CA); Roger ALOUCHE, Ajax (CA); Kirk MOSS, Oakville (CA); Chris EVANSON-CANEPA, Grand Valley (CA); Sam HUTCHEON, Cambridge (CA); Kirk Edward SERJEANTSON, Markham (CA)

(72) Inventors: Cameron James LAIRD, Milton (CA); Roger ALOUCHE, Ajax (CA); Kirk MOSS, Oakville (CA); Chris EVANSON-CANEPA, Grand Valley (CA); Sam HUTCHEON, Cambridge (CA); Kirk Edward SERJEANTSON, Markham (CA)

(73) Assignee: PUROLATOR INC., Mississauga (CA)

(21) Appl. No.: 13/589,323

(22) Filed: Aug. 20, 2012

Related U.S. Application Data
(60) Provisional application No. 61/525,425, filed on Aug. 19, 2011.

(51) Int. Cl. G06Q 10/08

(52) U.S. Cl. CPC G06Q 10/0835
USPC 705/336

(57) ABSTRACT

A system includes a sender application transmitting sender data for delivery items. A portable device carried by a courier transmits courier data for the items. Courier processors automatically generate a manifest which reconciles the sender data and courier data for each item. A courier database electronically stores the manifest. The system and included portable device, along with a corresponding method and computer readable medium, facilitate cost recovery for the items delivered by the courier.

### FIELD OF THE INVENTION

The present invention relates generally to a courier data reconciliation system, method, device and computer readable medium, and more particularly to a courier data reconciliation system, method, device and computer readable medium for use in association with items carried by a courier from a sender to a destination.

### BACKGROUND OF THE INVENTION

In the courier industry, courier systems (or shipping provider systems) and sender facing applications may communicate in order to exchange information between a courier (or shipping provider) and a sender (or customer). Communication between the courier systems and sender facing applications may facilitate the transportation of customer packages, parcels, pieces and other items by the courier from a sender pickup location to a destination.

Among couriers, it may be known to use manifests to catalog characteristics and/or information associated with items for transport, such as item dimensions, item weight, pickup location for items, destination of items, item identification, and special charges associated with the transport of items. Manifests may preferably, but need not necessarily, be prepared in an electronic format as manifest data. In order to improve customer convenience and to streamline the shipping process, it may also be known to provide senders with the ability to prepare the manifests using sender facing applications. Sender-prepared manifests may then be transferred to the courier system for use in association with the items for transport or delivery.

As may be appreciated by persons having ordinary skill in the art, shipping providers may also use manifests to generate customer invoices. The ability of shipping providers to recover revenue based on these invoices depends on the accuracy of the manifests received by the courier system. More specifically, for example, if a courier system receives a manifest from a sender which does not identify all of the items that have been delivered for the sender, the shipping provider may not receive payment for any items that may have been transported but not included on the manifest, and/or may have difficulty in obtaining payment for delivering the item(s) and the customer might receive free item transport. Similarly, if a courier system receives a delayed or incomplete sender-prepared manifest due to an interruption in communication between the courier system and sender facing application, the shipping provider may not be able to invoice the customer, may not be able to invoice the customer within acceptable time intervals, and/or may not receive any payment for items that have been transported but not included on the incomplete manifest.

In the prior art, courier systems and sender facing applications may not have communicated to exchange software version data. The ability of shipping providers to recover revenue may depend on ensuring that the software version data of the courier system and sender facing applications are current and/or correct. This may ensure that any updates to the software version (e.g., new features and/or repair of software defects) are present in both the courier system and sender facing application. Any delays in updating the software version of the sender facing application—due to, for example, communication interference, customer delay in advising the shipping provider of any need to update the sender facing application software version, and/or inavailability of a technician to attend to the software version update—may decrease efficiencies and/or revenues associated with the items to be delivered.

The transfer of manifest data and/or software version data between the sender facing application in communication with the courier system may have been negatively affected by: (1) limited or poor connectivity between the courier system and sender facing application; (2) intermittent transmission of manifest data; (3) an inability to establish connectivity between the courier system and sender facing application; (4) security and/or coverage issues; (5) customer interference with the sender facing application; (6) customers preventing manifest data from being sent to the courier system; (7) and/or customers preventing software updates from being received by the sender facing application.

In the prior art, some customers may not have allowed couriers to transmit manifest data or software version data (whether over the sender and/or courier network or otherwise) and/or may have prevented or impaired the sender facing application from sending manifest data to the courier or receiving software updates from the courier. For one or more of the foregoing reasons, shipping providers may have previously found it difficult to ensure customers were accurately invoiced on a timely basis. In the prior art, some shipping providers may have employed a device to facilitate the transmission of manifest data and software version data between the sender facing application and the courier system via wireless communication (e.g., GPRS or general packet radio service). Such wireless communication means, however, may have been limited by coverage and/or may have permitted customers to stop manifest data and software version data transfers by disconnecting the device.

It may present a security issue for couriers to negotiate the use of customers' internal networks to facilitate the transmission of manifest data and/or software version data. Undesirably, it may also permit customers to impair and/or prevent manifest upload by disconnecting the device. In addition, some customers may not want couriers using their networks.

It may be desirable to modify a prior art shipping system to provide: (a) global positioning system (“GPS”)-assisted tracking of deliveries and/or pickups; (b) a system for determining if a pickup time and/or item identification have been uploaded to the shipping system; and/or (c) an item monitoring and/or controlling apparatus for real-time item pickup and/or delivery. Previous systems and/or methods may have also allowed for item tracking and/or monitoring, for coordinating multiple couriers to ship items, and/or for global Internet-based shipping and/or tracking networks.

Perhaps notably, however, the devices, systems and/or methods of the prior art may not have been adapted to solve the one or more of the above-identified problems negatively affecting shipping systems. The systems, methods, devices and/or computer readable medium of the prior art may not have been adapted to enable transmission of data to a courier system at end of day or otherwise, nor to perform pickup reconciliation and avoid errors by reconciling the manifest with proof of pickup (“POP”) scans.

Prior art systems, methods, devices, and/or computer readable medium may have failed to solve problems which may arise in situations of limited cellular and/or wireless connectivity, when manifest data may only be stored locally in a customer system, and/or transmitted upon reestablishment of connectivity between the sender facing application and the courier system. Prior systems, methods, devices and/or computer readable medium also may not have been enabled transfer of manifest data that is formatted and/or encrypted into packets and/or chunks to facilitate an efficient resumption of communications after interruption and subsequent reestablishment of connectivity. Moreover, previous systems, methods, devices, and/or computer readable medium may not have enabled transmission of complete manifest data, or any unprocessed transactions, to a mobile courier scanner device after interrupting the processing of transactions (including, for example, prior transmission to the courier system).

What may be needed is system, method, device and/or computer readable medium that overcomes one or more of the limitations associated with the prior art and/or affords a work-around for security issues. It may be advantageous to provide a system, method, device and/or computer readable medium which affords a fail-safe to identify items intended for transport that have not been included on a manifest and/or to facilitate the transfer of manifest data to the courier system, including for example after manifest data transfer may have been interrupted. There may also be some advantage to providing a system, method, device and/or computer readable medium that preferably enables a one-to-one link between a portable unit and the sender facing application. The portable unit may preferably serve to identify items intended for transport that have not been included on a manifest and/or serve as a data transfer mechanism to the courier system.

What may be missing from the prior art is a system, method, device and/or computer readable medium which enables reconciliation of a customer-prepared manifest (containing information associated with the items intended for transport) with a courier-prepared manifest and/or transmission of manifest data to the courier system if communication between the courier system and sender facing application is interrupted. A contemplated system, method, device and/or computer readable medium of this general type may be desirable and/or may afford advantageous utility for courier systems and couriers, among other possible users. This reconciliation may help to increase the revenue associated with the items carried by the shipping provider.

It may be desirable for such a system, method or device to reconcile identity information, dimension information, weight information, destination information, special handling information, and courier instructions for one or more of the items for transport to reduce sender, transport, courier and/or delivery errors and/or to increase the revenue associated with the items carried by the shipping provider.

It may be desirable for such a system, method or device to analyze characteristics associated with the courier, the sender and/or the delivery (e.g., software versions, delivery locations, courier vehicle capacity, communication status) to reduce errors and/or to increase the revenue associated with the items carried by the shipping provider.

It may also be desirable to physically store, on a computer readable medium, instructions for execution by one or more processors to implement such a system and/or method.

It may be an object of one aspect of the present invention to provide a system, method, device and/or computer readable medium to help reduce errors and/or to increase the revenue associated with items carried by a shipping provider.

It may be an object of one aspect of the present invention to provide a system, method, device and/or computer readable medium adapted for use in parcel delivery or postal applications, and/or in association with transporting items to trailers, transporting of parcels, and/or improving or facilitating movement of freight.

It may be an object of one aspect of the present invention to provide a system, method, device and/or computer readable medium for use in association with scanner assisted data transfer.

It may be an object of one aspect of the present invention to provide a system, method, device and/or computer readable medium for use in association with transfer and/or generation of data packets.

It may be an object of one aspect of the present invention to provide a system, method, device and/or computer readable medium for use in association with transfer and/or generation of encrypted data.

It may be an object of one aspect of the present invention to provide a means for timely transfer of data to a courier's backend.

It may be an object of one aspect of the present invention to provide a means for updating a software version of the sender facing application.

It may be an object of one aspect of the present invention to ensure that data is received, and/or to maximize, improve or facilitate the collection of data, from a sender facing application by the courier's backend.

It may be an object of one aspect of the present invention to facilitate data transmission to the courier's backend, and preferably to facilitate data transmission to the courier's backend if data transmission is impaired and/or prevented.

It is an object of the present invention to obviate or mitigate one or more of the aforementioned disadvantages and/or shortcomings associated with the prior art, to provide one of the aforementioned needs or advantages, and/or to achieve one or more of the aforementioned objects of the invention.

### SUMMARY OF THE INVENTION

According to the invention, there is disclosed a system for use with items for delivery by a courier from a sender to one or more destinations. The system includes one or more sender processors local to the sender, at least one portable device carried by the courier, one or more courier processors, and a courier database remote from the sender. The sender processors are operative to execute a sender facing application to collect and transmit sender item data for the items. The portable device includes one or more portable device processors that are operative to collect and transmit courier item data for the items. The courier processors are operative to electronically receive the sender item data from the sender processors and the courier item data from the portable device processors, and to automatically generate a manifest for cost recovery. The manifest comprises a reconciled combination of the sender item data and the courier item data for each of the items. The courier database electronically stores the manifest. Thus, according to the invention, the system is operative to facilitate cost recovery for the items delivered by the courier.

According to an aspect of one preferred embodiment of the invention, the portable device may preferably, but need not necessarily, include a scanner operative to read, for each one of the items, a unique identification tag associated with the aforesaid each one in order to collect the courier item data.

According to another aspect of one preferred embodiment of the invention, the reconciled combination of the sender item data and the courier item data may preferably, but need not necessarily, include dimension data, weight data, destination data, special handling data if any, and/or special services data if any for each of the items.

According to yet another aspect of one preferred embodiment of the invention, if transmission of the sender item data is temporarily interrupted, the sender processors and the courier processors may preferably, but need not necessarily, be operative to transmit and receive, respectively, the sender item data as a plurality of discrete data packets for subsequent automatic assembly and generation of the manifest by the courier processors as aforesaid.

According to another aspect of one preferred embodiment of the invention, if transmission of the courier item data is temporarily interrupted, the portable device processors and the courier processors may preferably, but need not necessarily, be operative to transmit and receive, respectively, the courier item data as a plurality of discrete data packets for subsequent automatic assembly and generation of the manifest by the courier processors as aforesaid.

According to still another aspect of one preferred embodiment of the invention, the system may preferably, but need not necessarily, further include a geographic tracking device operative to obtain location data for the courier from a geographic information system and to automatically associate the location data with each of the items being delivered by the courier.

According to another aspect of one preferred embodiment of the invention, the portable device processors and/or the courier processors may preferably, but need not necessarily, be operative (i) to automatically determine the location data when each one of the items is delivered by the courier, and (ii) if the location data differs from the destination data for each of the items, to automatically generate an alert for presentation to a user of the system.

According to a further aspect of one preferred embodiment of the invention, the portable device processors and/or the courier processors may preferably, but need not necessarily, be operative (i) to automatically determine if the sender facing application requires updating, and (ii) in such event, to automatically update the sender facing application.

According to yet another aspect of one preferred embodiment of the invention, the portable device processors and/or the courier processors may preferably, but need not necessarily, be operative (i) to automatically determine remaining capacity data for the courier, using dimension data to calculate volume data for each of the items for delivery by the courier and summing together the volume data, and (ii) if the remaining capacity data is lower than a predetermined target therefore, to automatically generate an alert for presentation to a user of the system.

According to an aspect of one preferred embodiment of the invention, (i) the sender processors and/or the courier processors may preferably, but need not necessarily, be operative to automatically determine if communication between the sender processors and the courier processors is interrupted, and (ii) in such event, the sender processors automatically transmit the sender item data to the portable device and, subsequently, the courier processors automatically receive the sender item data from the portable device processors.

According to an aspect of one preferred embodiment of the invention, the courier processors may preferably, but need not necessarily, be operative to electronically receive the sender item data and the courier item data via the courier database.

According to a further aspect of one preferred embodiment of the invention, the courier database may preferably, but need not necessarily, electronically store one or more updated versions of the manifest, the sender item data and/or the courier item data at least once a day.

According to a further aspect of one preferred embodiment of the invention, the courier processors may preferably, but need not necessarily, be located remotely from the sender and/or the courier database may preferably, but need not necessarily, be located remotely from the portable device and/or the sender.

According to yet another aspect of one preferred embodiment of the invention, the portable device may preferably, but need not necessarily, further comprise a portable device database located remotely from the courier database, and which stores one or more versions of the manifest, the sender item data, and/or the courier item data that are stored in the courier database.

According to the invention, there is also disclosed a method for use in association with the delivery of items by a courier from a sender to one or more destinations. The method includes steps (a), (b), (c), and (d). Step (a) involves operating one or more sender processors, local to the sender, to execute a sender facing application to collect and transmit sender item data for the items. Step (b) involves operating one or more portable device processors of at least one portable device, carried by the courier, to collect and transmit courier item data for the items. According to the invention, step (c) involves operating one or more courier processors to electronically receive the sender item data from the sender processors and the courier item data from the portable device processors, and to automatically generate a manifest, for cost recovery. Such manifest includes a reconciled combination of the sender item data and the courier item data for each of the items. Step (d) involves electronically storing the manifest in a courier database remote from the sender. Thus, according to the invention, the method operatively facilitates cost recovery for the items delivered by the courier.

According to an aspect of one preferred embodiment of the invention, in step (b), the portable device may preferably, but need not necessarily, collect the courier item data by operating a scanner of the portable device to read, for each of the items, a unique identification tag associated with each of the items.

According to an aspect of one preferred embodiment of the invention, in step (c), the reconciled combination of the sender item data and the courier item data may preferably, but need not necessarily, include dimension data, weight data, destination data, special handling data if any, and/or special services data if any for each of the items.

According to another aspect of one preferred embodiment of the invention, if transmission of the sender item data is temporarily interrupted, the sender processors may preferably be operative in step (a) to transmit and the courier processors may preferably be adapted in step (c) to receive the sender item data as a plurality of discrete data packets, preferably for subsequent automatic assembly and/or generation of the manifest by the courier processors as aforesaid.

According to still another aspect of one preferred embodiment of the invention, if transmission of the courier item data is temporarily interrupted, the portable device processors may preferably be operative in step (b) to transmit and the courier processors may preferably be adapted in step (c) to receive the courier item data as a plurality of discrete data packets, preferably for subsequent automatic assembly and/or generation of the manifest by the courier processors as aforesaid.

According to another aspect of one preferred embodiment of the invention, the method preferably, but need not necessarily, further comprise a step of operating a geographic tracking device to obtain location data for the courier from a geographic information system and preferably, but not necessarily, to automatically associate the location data with each of the items being delivered by the courier.

According to yet another aspect of one preferred embodiment of the invention, in step (b) the portable device processors and/or in step (c) the courier processors may preferably, but need not necessarily, be operative (i) to automatically determine the location data when each one of the items is delivered by the courier, and (ii) if the location data differs from destination data for said each one, to automatically generate an alert for presentation to a user of the system.

According to another aspect of one preferred embodiment of the invention, in step (b) the portable device processors and/or in step (c) the courier processors may preferably, not need not necessarily, be operative (i) to automatically determine if the sender facing application requires updating, and (ii) in such event, to automatically update the sender facing application.

According to another aspect of one preferred embodiment of the invention, in step (b) the portable device processors and/or in step (c) the courier processors may preferably, but need not necessarily, be operative (i) to automatically determine remaining capacity data for the courier, using dimension data to calculate volume data for each of the items for delivery by the courier and summing together the volume data, and (ii) if the remaining capacity data is lower than a predetermined target therefor, to automatically generate an alert for presentation to a user of the system.

According to yet another aspect of one preferred embodiment of the invention, the method may preferably, but need not necessarily, further include the steps of (i) operating the sender processors in step (a) and/or the courier processors in step (c) to automatically determine if communication between the sender processors and the courier processors is interrupted, and (ii) in such event, operating the sender processors in step (a) to automatically transmit the sender item data to the portable device and, preferably but not necessarily, subsequently operating the courier processors in step (c) to automatically receive the sender item data from the portable device processors.

According to still another aspect of one preferred embodiment of the invention, in step (c) the courier processors may preferably, but need not necessarily, be operative to electronically receive the sender item data and the courier item data via the courier database.

According to an aspect of one preferred embodiment of the invention, in step (d) the courier database may preferably, but need not necessarily, electronically store one or more updated versions of the manifest, the sender item data and/or the courier item data at least once a day.

According to another aspect of one preferred embodiment of the invention, in step (c) the courier processors may preferably, but need not necessarily, be located remotely from the portable device and/or the sender, and/or in step (d) the courier database may preferably, but need not necessarily, be located remotely from the portable device.

According to still another aspect of one preferred embodiment of the invention, the method nay preferably, but need not necessarily, further include the step of storing, in a portable device database of the portable device which is preferably remote from the courier database, one or more versions of the manifest, the sender item data and/or the courier item data that are stored in the courier database.

It may be worthwhile to note that two or more steps of the method may be performed, wholly or in part, substantially contemporaneous with one another and/or in any order which may be desirable, appropriate, and/or necessary according to the invention, such as may be appreciated by persons having ordinary skill in the art in view of the disclosures herein.

According to the invention, there is also disclosed a portable device such as may be carried by a courier. The portable device is for use in association with a sender processor local to a sender. The sender processor executes a sender facing application which collects and transmits sender item data for items to be delivered to one or more destinations. The portable device is also for use with a courier database remote from the sender, and with a courier processor which electronically receives the sender item data from the sender processors. The device includes a scanner and one or more portable device processors. The scanner is operative to read, for each one of the items, a unique identification tag associated with said each one, so as to collect courier item data. The portable device processors are operative to collect the courier item data from the scanner and electronically transmit the courier item data to the courier processor for automatic generation of a manifest for cost recovery. Such manifest includes a reconciled combination of the sender item data and the courier item data for each of the items. The manifest is electronically stored in the courier database. Thus, according to the invention, the portable device is operative to facilitate cost recovery for the items delivered by the courier.

According to the invention, there is also disclosed a computer readable medium on which is physically stored executable instructions. The executable instructions are such as to, upon execution, generate a manifest for cost recovery. The computer readable medium is for use in association with the delivery of items by a courier from a sender to one or more destinations. The executable instructions include processor instructions for one or more sender processors local to the sender, portable device processors of at least one portable device carried by the courier, and/or courier processors to automatically and according to the invention: (a) collect and/or electronically communicate sender item data for the items from the sender processors to the courier processors; (b) collect and/or electronically communicate courier item data for the items from the portable device processors to the courier processors; (c) automatically generate the manifest which includes a reconciled combination of the sender item data and the courier item data for each of the items; and (d) electronically store the manifest in a courier database remote from the sender. Thus, according to the invention, the computer readable medium operatively facilitates cost recovery for the items delivered by the courier.

Other advantages, features and characteristics of the present invention, as well as methods of operation and functions of the related elements of the system, method, device and computer readable medium, and the combination of steps, parts and economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the system, method, device and computer readable medium according to the present invention, as to their structure, organization, use, and method of operation, together with further objectives and advantages thereof, will be better understood from the following drawings in which presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a schematic diagram of a system and device for use with items for delivery by a courier according to one preferred embodiment of the invention;

FIG. 2 is a schematic diagram of components of the system and device of FIG. 1;

FIGS. 3A and 3B are, taken together, a flowchart of an over-arching method according to a preferred embodiment of the invention;

FIG. 4 is a flowchart of a software version subroutine for steps of the method shown in FIG. 3B;

FIG. 5 is a flowchart of a location subroutine for steps of the method shown in FIG. 3B;

FIG. 6 is a flowchart of a courier capacity subroutine for steps of the method shown in FIG. 3B; and

FIG. 7 is a flowchart of a communication link subroutine for steps of the method shown in FIG. 3B.

### DETAILED DESCRIPTION OF THE PREFERRED EMBODIMENTS

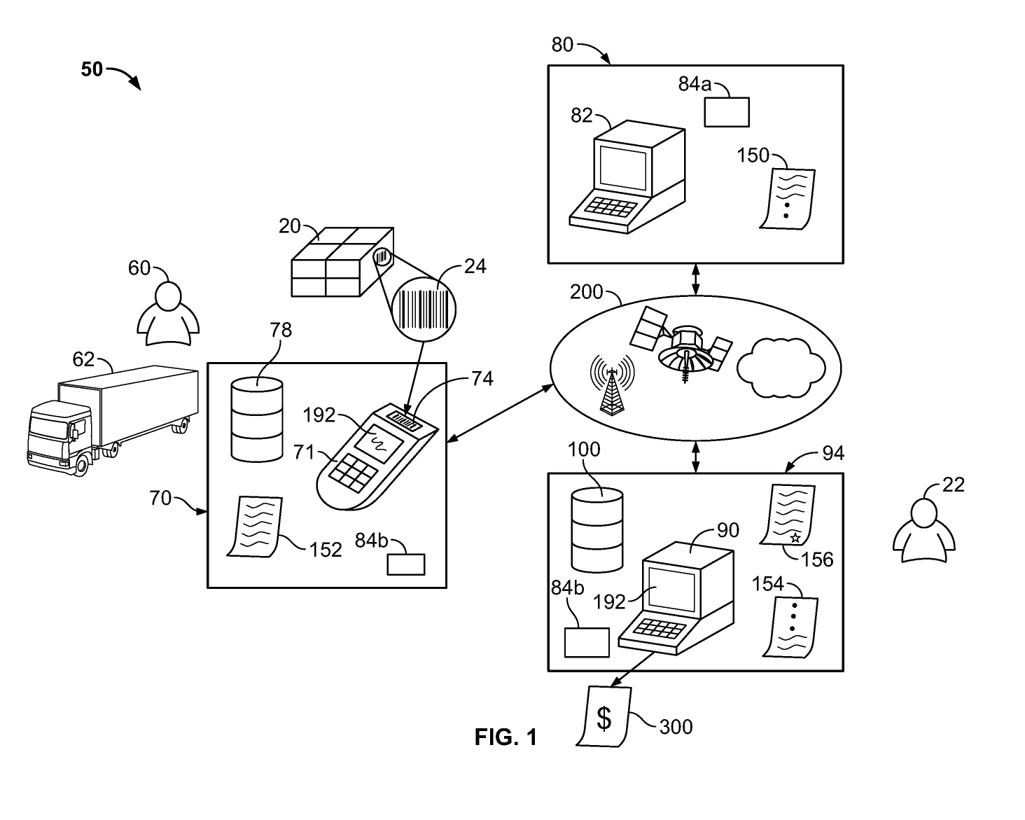

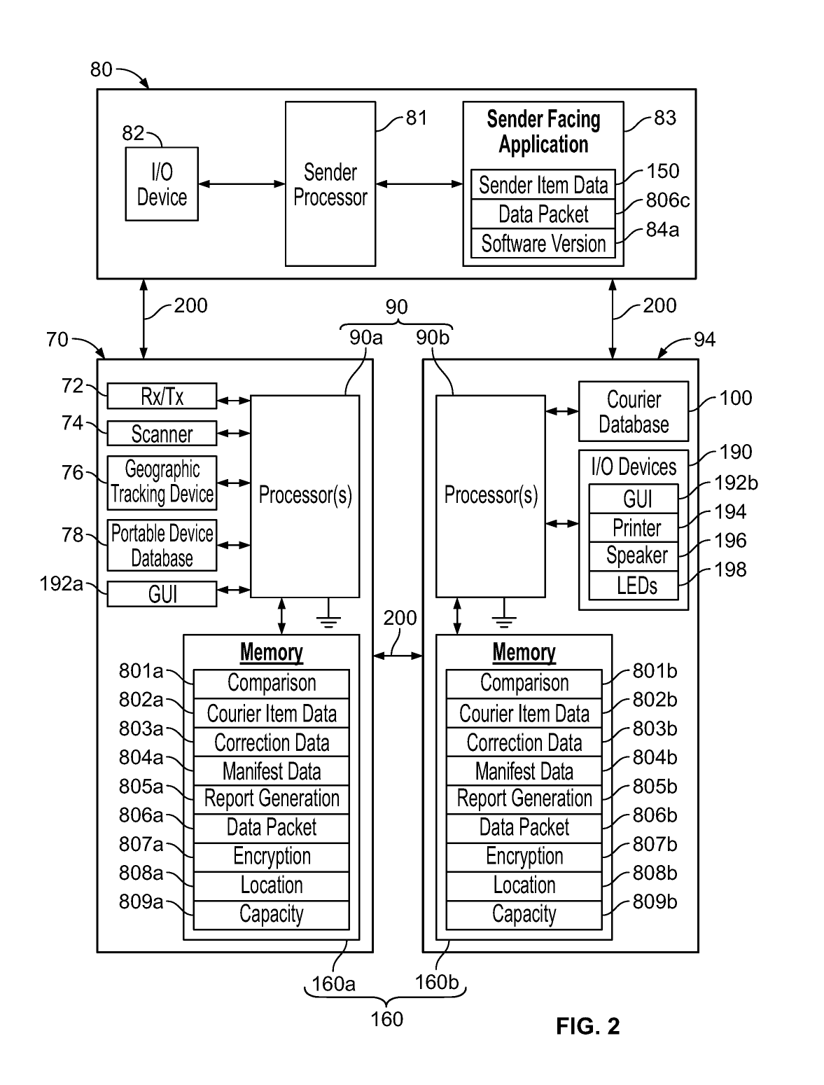

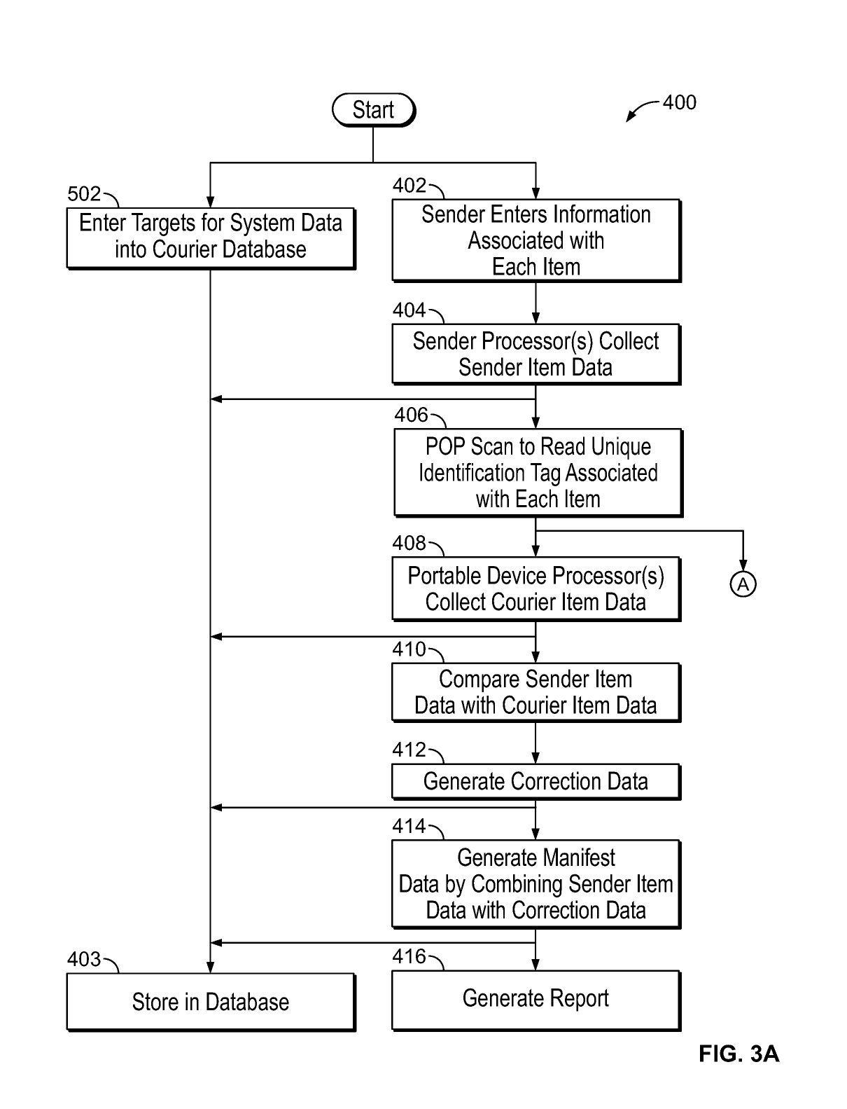

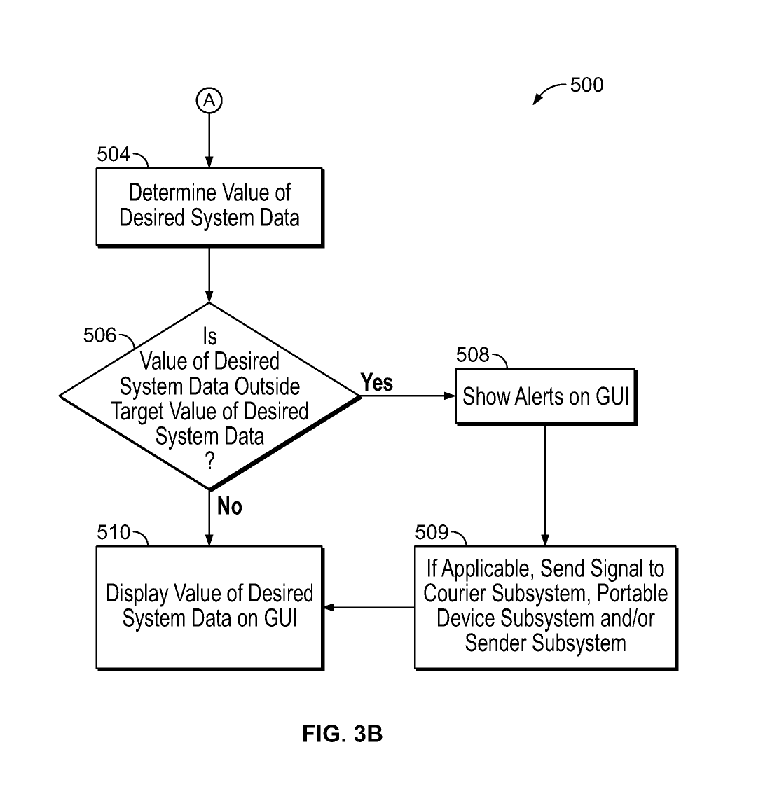

Referring to FIG. 1, there is shown a system 50 for use with items 20 delivered by a courier 60. FIGS. 3A through 7 show steps performed according to a related method 400. FIGS. 1 and 2 show a portable device 71 for use in association with the system 50 and the method 400 and/or under influence of a related computer readable medium 160. The courier 60 may typically deliver the items 20 from a sender or sender location to a destination within a facility or remote from each other.

The system 50 depicted in FIG. 1 may be used within a single facility and/or multiple facilities. For example, some of the components of the system 50 may be provided at a remote location. Each of the items (alternately, herein, “packages” or “parcels”) 20 has a unique identification tag 24, preferably, a barcode affixed thereto. The packages 20 preferably constitute freight or other items moving within a mail system or within a distribution system generally.

Preferably, and as best seen in FIG. 1, the system 50 includes a sender subsystem 80, a portable device subsystem 70, and a courier subsystem 94.

In FIGS. 1 and 2, the system 50 is shown in use with a communication network 200. The communication network 200 may include satellite networks (e.g., GPS), terrestrial wireless networks, and the Internet. The communication of data between the sender subsystem 80, the portable device subsystem 70 and/or the courier subsystem 94 may be also be achieved via one or more wired means of transmission (e.g., docking the portable device 71 in a base station of the sender subsystem 80 and/or the courier subsystem 94), or other physical means (e.g., a Universal Serial Bus cable and/or flash drive) of transmission. Persons having ordinary skill in the art will appreciate that the system 50 includes hardware and software.

FIG. 2 schematically illustrates, among other things, that the sender subsystem 80 includes a sender input-output device 82 (e.g., for entering sender item data 150) and a sender processor 81 operative to execute a sender facing application 83. The portable device subsystem 70 includes a portable device processor 90a, a transmitter-receiver 72, a scanner 74, a geographic tracking device 76, a portable device database 78, a graphical user interface 192a, and a computer readable medium (e.g., an onboard portable device processor-readable memory) 160a local to the portable device processor 90a. The courier subsystem 94 includes a courier processor 90b, a courier database 100, and a computer readable medium (e.g., a processor-readable memory) 160b local to the courier processor 90b. The courier subsystem 94 is shown, in FIG. 2, to further include input-output devices (e.g., a printer for generating reports such as invoices) 190.

Sender Subsystem

As best seen in FIG. 2, the sender subsystem 80 includes the sender input-output device 82 (also shown in FIG. 1) and the sender processor 81 operative to execute the sender facing application 83. The sender facing application 83 preferably allows senders to schedule the pickup of items 20 for delivery by the courier 60. The sender facing application 83 is preferably adapted to collect sender item data 150 including information associated with each of the items 20, to determine a cost to ship the items 20 from the sender or the sender location to a destination, and/or to produce a compliant shipping label or the unique identification tag 24 for the items 20. The sender facing application 83 is preferably software of a particular software version 84a.

Preferably, the sender inputs information associated with each of the items 20 into the sender input-output device 82 to thus collect the sender item data 150. The sender item data 150 may additionally include information such as shipping location (i.e., address of sender), item weight, item dimensions, special services, item description, number of pieces, pin numbers, destination information and/or mode of transport.

Following collection of the sender item data 150, the sender processor 81 may preferably transmit the sender item data 150 to the courier processors 90b. Preferably, the sender processor 81 may:
(i) be enacted by the portable device processors 90a substantially contemporaneous with or following a POP scan 75;
(ii) communicate with the portable device processors 90a;
(iii) review the status of the sender item data 150 to:
   (A) determine whether the sender processor 81 has transmitted the sender item data 150, processed or otherwise, to the courier processors 90b; and/or
   (B) determine whether any new and/or unprocessed sender item data 150 has been created since the last transmission; and/or
(iv) if the sender item data 150 needs to be transmitted:
   (A) output the sender item data 150 as a text file; and/or
   (B) transmit the sender item data 150 as the text file to the portable device processors 90a and/or the courier processors 90b.

For wireless communication with the portable device processors 90a and/or the courier processors 90b, the sender processor 81 may preferably leverage the communication network 200.

Portable Device

As best seen in FIGS. 1 and 2, the portable device 71 preferably includes the scanner 74 and the portable device database 78. As shown in FIG. 2, it also includes the geographic tracking device 76, the transmitter-receiver 72, the portable device processors 90a, and the graphical user interface (“GUI”) 192a.

Preferably, the portable device 71 uses the scanner 74 to automatically read the unique identification tags 24 from the items 20. The scanner 74 is preferably a barcode scanner. The scanner 74 can be an imager, or a laser-based scanner. [The scanner 74 may instead be a radio-frequency identification (“RFID”) scanner. When an RFID scanner is provided, one or more of the identification tags 24 on the items 20 are RFID tags.] Using the transmitter-receiver 72, the portable device processors 90a may be wired to communicate with—or may wirelessly communicate via the communication network 200 (for example, by the Bluetooth™ proprietary open wireless technology standard which is managed by the Bluetooth Special Interest Group of Kirkland, Wash.) with—the courier processors 90b and/or the sender processors 81. The scanner 74 is adapted to scan or read information (e.g., a barcode) from each item 20.

Preferably, the courier processors 90b communicate via the communication network 200 with the sender processors 81 to facilitate transmission of the sender item data 150 thereto. Thereafter or substantially contemporaneously, the portable device processors 90a preferably connect to the sender processor 81 via the communication network 200. The sender processor 81 preferably transmits all the sender item data 150 (either the entire set of the sender item data 150 or, preferably, any portions that have not been previously sent to the courier processors 90b) to the portable device processors 90a. This transfer of data to the portable device processors 90a preferably occurs while the items 20 are being scanned by the scanner 74 and/or loaded by the courier 60 (e.g., onto a courier transport 62).

Preferably, the portable device processors 90a may communicate directly with the sender processors 81 to detect, fix and/or obviate one or more otherwise troublesome communication issues between the sender processor 81 and the courier processors 90b, including: (a) preventing, reducing and/or obviating any sender interference with transmission of the sender item data 150; (b) limited, poor and/or no connectivity between the sender processors 81 and the courier processors 90b; and/or (c) ensuring that information needed for invoicing of items 20 is received by the courier 60 when the items 20 are picked up by the courier 60, preferably preventing senders from delaying transmission of the sender item data 150.

The portable device processors 90a may leverage point-to-point communications with the sender processor 81 instead of, or as a supplement to, communication through one or more hosted and/or non-hosted databases. The skilled reader may appreciate that the point-to-point solution may preferably be a substantially and/or highly stable communication link.

Preferably, after the portable device processors 90a establish communication with the sender processor 81, the sender facing application 83 parses the existing sender item data 150—preferably at a particular moment in time—and/or communicates relevant portions of the sender item data 150 to the portable device processors 90a. The portable device processors 90a preferably receive relevant sender item data 150 that has not previously been successfully sent to the courier database 100 and/or the courier processors 90b (i.e., items 20 that may not have previously been entered into the sender input-output device 82). This sender item data 150 may be received by the portable device processors 90a and, preferably, stored in the portable device database 78.

After arrival at the sender location, the courier 60 may preferably perform one or more POP scans using the scanner 74 of the portable device 71. Commencing the POP scans may initiate other processes and/or sequences according to the system 50 and method 400.

The portable device processors 90a may or may not communicate with other devices, and/or portions of its onboard application(s) may remain dormant—e.g., to save battery life—until a POP scan is initiated. After the POP scan is initiated, the onboard application may be activated, and the portable device processors 90a may establish communication with the sender processors 81 and/or the courier processors 90b.

In a preferred embodiment, the portable device subsystem 70 may comprise a hardware and/or software application that allows for the scanning of the freight 20 (e.g., a STA or scan track application) that has the capability to use the 802.11 protocol, Bluetooth communication and/or another linkage. For example, cellular communication and/or the communication network 200 may be used. Additional hardware and/or software portable device applications may be: (i) enacted on POP scan; (ii) connect wirelessly to the courier processors 90b (e.g., via Bluetooth, Wi-Fi, and/or another linkage); (iii) collect the sender item data 150 from the sender processor 81, and/or collect courier item data 152, correction data 154, manifest data 156, and/or the sender item data 150 from the courier processors 90b and/or from the courier database 100; and/or (iv) store the sender item data 150, the courier item data 152, the correction data 154, and/or the manifest data 156 in the portable unit database 78 for subsequent transmission to the courier database 100.

The sender item data 150, the courier item data 152, the correction data 154, and/or the manifest data 156 stored in the portable device database 78 may be transmitted to the courier database 100 and/or the courier processors 90b at regular intervals throughout each day, and preferably at least by the end of each day. In an alternate embodiment, the portable device 71 may be a pass-through device, instead of or in addition to functioning as a storage device (e.g., via the portable device database 78). Instead of, or in addition to, storing sender item data 150 and/or courier item data 152 in the portable device database 78, the data 150, 152, 154, 156 may preferably be transmitted in real-time using the transmitter-receiver 72 to the courier processors 90b and/or the courier database 100.

The sender item data 150 and the courier item data 152 may be transmitted to the courier database 100, the courier processors 90b, and/or to a portable transmitter that may be associated with the courier transport 62 for real-time and/or subsequent transmission to the courier database 100 and/or courier processors 90b.

The portable device 71 is preferably a handheld scanner, as shown in FIG. 1, such as, for example, one of those used in warehouses and/or by courier drivers—much like a personal digital assistant and/or a smart phone, except with a rugged design and/or robust scanning capabilities (e.g., the MC70 device offered by Motorola Solutions, Inc. of Schaumburg, Ill.).

Processors

Preferably, the processors 90—i.e., the portable device processors 90a and/or the courier processors 90b—are operatively encoded with one or more algorithms 801a, 801b, 802a, 802b, 803a, 803b, 804a, 804b, 805a, 805b, 806a, 806b, 807a, 807b, 808a, 808b, and/or 809a, 809b (shown schematically in FIG. 2 as being stored in the memory associated with the portable device subsystem 160a and/or the courier subsystem 160b) which provide the processors 90 with comparison logic 801a, 801b, courier item data collection logic 802a, 802b, item data correction logic 803a, 803b, manifest generation logic 804a, 804b, report generation logic 805a, 805b, data packet generation logic 806a, 806b, data encryption logic 807a, 807b, location logic 808a, 808b, and/or capacity logic 809a, 809b. Preferably, the algorithms 801a, 801b, 802a, 802b, 803a, 803b, 804a, 804b, 805a, 805b, 806a, 806b, 807a, 807b, 808a, 808b, and/or 809a, 809b enable the processors 90 to assess the sender item data 150 received from the sender processor 81 and/or the courier item data 152 received from the portable device processors 90a as well as any additional system data that may be associated with the system 50. The courier processors 90b and/or the portable device processors 90a are also preferably operatively connected to one or more power sources.

The courier processors 90b are preferably in communication with the sender processor 81 and/or the portable device processors 90a. Preferably, the courier processors 90b may be used to automatically: (i) compare the sender item data 150 against the courier item data 152 to generate the correction data 154; and (ii) generate the manifest data 156 which includes a combination of the sender item data 150 with the correction data 154.

The courier processors 90b may be optionally configured to automatically: (i) compare the sender item data 150 with the courier item data 152; and (ii) generate the manifest data 156 by replacing the sender item data 150 in favour of the courier item data 152.

For one or more and preferably all of the items 20, the sender item data 150 and the courier item data 152 may include dimension information, weight information, destination information, special handling information if any, and/or special instructions if any. The correction data 154 is generated based on any differences between the sender item data 150 and the courier item data 152 for each of the items 20. The manifest data 156 preferably includes a combination of the sender item data 150, the courier item data 152, and/or the correction data 154. The manifest data 156 is preferably a reconciled combination of the sender item data 150 and the courier item data 152.

The sender item data 150 may be in the form of, or it may include, an electronic file created by the sender facing application 83. The sender item data 150 may include ship to and from information (e.g., sender information and destination information), as well as an indication of any special services to be applied to the parcels 20. The courier 60, the portable device subsystem 70 and/or the courier subsystem 94 may use the manifest data 156 to invoice senders for delivery services rendered.

Preferably, the courier processors 90b may generate the manifest data 156 during, after, or substantially contemporaneous with item 20 pickup while the courier 60 is at the sender location 32, and/or only when the sender item data 150 and the courier item data 152 have been received by the courier processors 90b and/or the courier database 100. Preferably, instead of (or in addition to) validating a courier's day via GPS and/or pickup and delivery sequencing, the portable device processors 90a and/or the courier processors 90b may: (a) download the sender item data 150 (e.g., a list of all parcels 20 processed for pickup on that specific day) to the portable device processors 90a; and/or (b) cross reference the sender item data 150 with the courier item data 152 that includes all parcels 20 that were physically scanned by the courier 60 as received that day. If the courier 60 picks up a piece 20 that was included in the sender item data 150 or if the courier 60 has forgotten to pick up a piece 20, an alert may be sent to the courier 60 and/or a user 22 of the system 50. For example, the courier 60 and/or user 22 may be alerted that one or more of the items 20 picked up from the sender have not been billed. In this way, cost recovery by the courier 60 may be maximized since, otherwise, if a parcel 20 is picked up that had not been previously included amongst the sender item data 150, the shipping provider may have difficulty in obtaining payment for delivering that parcel 20 and the sender might receive free delivery.

Preferably, the portable device processors 90a and/or the courier processors 90b automatically determine, at regular intervals, system data associated with the system 50 and/or the items 20. Some of the system data may include the software version 84a of the sender facing application 83, location data of the items 20 delivered by the courier 60, courier capacity, and the status of any communication link between the sender processor 81 and the courier processors 90b.

The processors 90 may merge the determined system data with information concerning the items 20 (e.g., identification, dimensions, weight, etc.), and preferably transmit this data to the courier database 100 and/or the portable device database 78. In this manner, the merged data may later be retrieved by tracking and invoicing functions integrated within a larger operation, for example, at a facility (e.g., courier subsystem 94) or across multiple facilities. These functions may, for example, be “backend” functions in the sense that they may not be performed at the site of the sender and/or local to other functions associated with the system 50.

The system data may be determined in a variety of ways, and a variety of system data may be determined. In many cases, the system data may be determined over a particular time interval or between two or more locations. The time interval may be determined by the user 22 and/or the courier 60 as needed (e.g., following a POP scan), or it may be a predetermined one.

The system data may be associated with pre-determined targets and/or preferences. For example, the courier 60 may determine, prior to pickup and/or delivery, that it will be preferable for the communication between the sender processor 80 and the courier processors 90b to be continuous or for it not to be interrupted for more than thirty seconds. Preferably, the pre-determined targets for the system data are stored in the courier database 100 and/or the portable unit database 78.

Preferably, the portable device 71 may also be used as an audit device by comparing the system data associated with the items 20 with the pre-determined targets for the system data. A technician may be dispatched if an issue is discovered.

The system 50 may also be useful in network optimization and/or in helping the shipping provider to retrieve and/or determine all relevant data at the time of pickup, or substantially contemporaneous therewith. For example, this may allow for downstream systems (not shown) to understand incoming volumes of parcels 20. This optimization may preferably, but need not necessarily, help the shipping provider with staffing and/or equipment.

Courier Database

As may be best appreciated by a consideration of FIG. 1, the courier database 100 is preferably included within the courier subsystem 94 and located remotely from the sender subsystem 80 and the portable device subsystem 70.

The courier database 100 includes, and is regularly updated with, the sender item data 150, the courier item data 152, the correction data 154 and/or the manifest data 156. The system 50 may include other databases, such as, for example, a portable device database 78.

The databases 78, 100 include information associated with the items 20 such as the following information: dimension information; weight information; destination information; special handling information; and/or special instruction information. Dimension information may be the external dimensions of an item 20. Weight information may be the weight of an item 20. Destination information may be the address information of the intended receiver for an item 20. Special handling information may include any surcharges for conveying oversized and/or oddly shaped items 20. Special instruction information may include any specific delivery instructions of the items 20 for the courier 60 (e.g., direction information and/or expedited, express or priority delivery requests).

All or part of the databases 78, 100 may be located behind a firewall relative to the communications networks 200. Persons having ordinary skill in the art will appreciate that references herein to the courier database 100 and/or the portable unit database 78 may include, as appropriate, references to: (i) a single database located at a facility (e.g., in association with a courier subsystem 94), or on a unit, remote from the sender and/or at the same facility as the sender; and/or (ii) one or more congruent and/or distributed databases 78, 100, such as, for example, also including one or more sets of congruently inter-related databases 78, 100—possibly distributed across multiple facilities.

The sender processors 81 may or may not be otherwise adapted to (on their own) transmit the sender item data 150 to the courier processors 90b and/or the courier database 100. The system 50 may store the sender item data 150 and/or the courier item data 152—including shipment attributes for a particular shipping day (e.g., shipping location, weight, special services, product, number of pieces, pin numbers, destination information and/or mode of transport)—in the courier database 100 and/or the portable device database 78. Persons having ordinary skill in the art may appreciate that this storage aspect of the invention may be significantly different than storing simple tracking information.

Data Packets

Preferably, the sender item data 150, the courier item data 152, the correction data 154, and/or the manifest data 156 are divided or disassembled into a plurality of manageable and discrete data packets prior to transmission by the processors 90 and/or the sender processors 81 using the data packet algorithm 806. Following transmission, the plurality of discrete data packets are preferably automatically joined or reassembled into the corresponding sender item data 150, courier item data 152, correction data 154, and/or manifest data 156 by the processors 90 and/or the sender processor 81 using the data packet algorithm 806a, 806b.

The data packets may be data packets in the conventional sense, or they may be more akin to data “chunks”. That is, the present invention contemplates the use of any suitable way of segmenting and transmitting the sender item data 150 and/or the courier item data 152 for subsequent re-assembly at the backend. For example, all data associated with a specific item 20 may be transmitted together, with the information concerning all items 20 to be delivered being collected at the backend. Any items 20 for which only a partial record is received, or any items for which no data and/or corrupted data is received may be flagged for correction, follow-up and/or replacement. It is implicit from all of the foregoing that, when appropriate, data packets in the conventional sense may be suitable for incorporation in and/or use with the present invention.

Encryption

Preferably, the sender item data 150, the courier item data 152, the correction data 154, and/or the manifest data 156 are encrypted or de-encrypted (or decrypted) for secured transmission by the processors 81, 90 using the encryption algorithm 807a, 807b. Following transmission, the encrypted data is preferably automatically de-encrypted by the processors 81, 90 using the encryption algorithm 807a, 807b.

Communication Interruption

If the entire sender item data 150 has not been transmitted, the processed sender item data 150 is cut off and/or delineated and the sender item data 150 will remain open and/or considered un-transmitted.

Preferably, if the transmission of the sender item data 150 from the sender processors 81 is terminated, severed, interrupted and/or impaired—whether to the processors 90, the courier database 100 and/or the portable device database 78—then transmitted sender item data 150 that has been received by the courier database 100 and/or the courier processors 90b may be deleted (from the sender subsystem 80, the portable device subsystem 70, or both). Un-transmitted sender item data 150 that has not been received by the courier database 100 and/or the courier processors 90b may be received by and maintained on the portable device database 78 for subsequent transfer to the courier database 100 and/or the courier processors 90b when communication is restored. This may preferably ensure that if the courier 60 leaves the sender without full acquisition of the sender item data 150 (by the courier database 100 and/or the courier processors 90b), some usable data may remain within the portable device subsystem 70.

The portable device subsystem 70 may even replace the need for the sender processors 81 to have any other communication link to the courier subsystem 94. The sender item data 150 and the courier item data 152 may preferably both be transported by the portable device 71 to the courier database 100 and/or the courier processors 90b.

The courier 60 may arrive at the sender location, and the portable device processors 90a may retrieve the sender item data 150 from the sender processors 81. Preferably, the portable device processors 90a may compare the sender item data 150 against the courier item data 152. The portable device processors 90a may determine—preferably during, after and/or substantially contemporaneous with the POP scan process—if parcels 20 are missing and/or received without being properly included amongst the sender item data 150. Any issues may preferably then be highlighted to the shipping provider for remediation.

A courier 60 may arrive at the sender location when the sender has yet to transmit the sender item data 150 to the courier database 100 and/or the courier processors 90b. Then, the portable device processors 90a may establish communication with the sender processors 81, recognize that transmission of the sender item data 150 has not yet taken place, and then receive the previously un-transmitted sender item data 150.

The courier 60 may arrive at the sender location after the sender has commenced, but before it has completed, transmission of the sender item data 150 to the courier database 100 and/or the courier processors 90b—possibly with such transmission having been interrupted and/or stopped partway through its process. Preferably, the portable device processors 90a may then connect to the sender processors 81, and retrieve the un-transmitted data 150 for processing.

The courier 60 may arrive at the sender location after the sender has terminated transmission of the sender item data 150, and/or after it transmitted data 150 earlier in the day and has since then processed additional parcels 20 for delivery. Preferably, the portable device processors 90a then retrieve the un-transmitted sender item data 150 from the sender processor 81 for processing.

Location Data

Preferably, the processors 90 may also be used to confirm and/or reconcile one or more shipping addresses associated with the items 20. More specifically, using the location algorithm 808a, 808b the processors 90 may be used to compare the location data 77 generated by the geographic tracking device 76 (e.g., using GPS) to the destination information of the items 20. For example, latitude and/or longitude information residing in or retrieved by or from the portable device processors 90a and/or from the geographic tracking device 76 may preferably be translated into a delivery address and/or compared against a shipping location or destination information 42 declared in the sender item data 150 to ensure consistency, or to highlight any differences between the two.

Software Update

The processors 90 may read the software version 84a of the sender facing application 83 to determine if the version 84a is correct, current and/or out-of-date. In such event, the portable device processors 90a and/or the courier processors 90b are preferably adapted to update the sender facing application 83 and/or transmit an updated application 83 of the correct, current, and/or up-to-date software version 84b.

Preferably, the portable device processors 90a may be provided with the updated application 83 of the correct software version 84b. In updating and/or correcting the sender facing application 83, when a portable device 71 is onsite and/or its processor 90a is in communication with the sender processors 81, the portable device processor 90a preferably checks the software version 84a of the sender facing application 83 to ensure that it is correct and/or current. If not, the portable device processors 90a and/or the courier processors 90b may preferably send the updated application 83 of the correct software version 84b to the sender processors 81. All software updates may preferably be broken out into data packets and/or data chunks, so that the portable device processors 90a and/or the courier processors 90b may readily resume and/or continue with an existing transmission if the communication is disconnected, terminated and/or interrupted in process.

Courier Capacity

The processors 90, using the capacity algorithm 809a, 809b, may sum together the volume and/or weight of the items 20 delivered by the courier 60. Dimension information may be used to calculate the volume of each package 20. Dimension and/or weight information for each of the items 20 delivered by the courier 60 may be obtained from the manifest data 156 and used by the capacity algorithm 809a, 809b to sum together the volume and/or weight of the items 20 delivered by the courier 60. Preferably, the calculated volume and/or weight of the items 20 may be compared against a predetermined capacity for the courier 60 and/or the courier vehicle 62.

Preferably, the portable device processors 90a (or another processing element of the preferred embodiment of the present invention) may, substantially in real-time, calculate a remaining capacity for the courier 60 and/or the courier transport 62 (e.g., as a difference between the summed weights/volumes and the predetermined capacity). By reading the manifest data 156 from the courier database 100 and/or the portable device database 78, the portable device processors 90a or another portion of the present system 50 may preferably calculate the number (and possibly the size and weight) of the pieces 20 picked up throughout the day. Preferably, using dimensional and/or weight information provided by the courier database 100, the processors 90 may determine when the courier 60 is approaching and/or at capacity. When a predetermined threshold capacity is reached, the portable device processors 90a may preferably send a message to the shipping provider, the courier 60 and/or the sender that the courier 60 and/or the courier transport 62 is reaching its capacity and/or that another courier transport 62 may be required. The shipping provider may contact the courier 60 for confirmation and/or dispatch pickup instructions (e.g., using a Dynamic Mobile Dispatch (“DMD”)) to other couriers 60 and/or courier transports 62 with greater available capacity and/or remaining capacity.

Presentation

The processors 90 preferably generate a signal for presentation of the various data 150, 152, 154, 156 and the system data to the courier 60 and/or user 22 of the system 50. The data 150, 152, 154, 156 and the system data may be presented by the system 50 using a graphical user interface (“GUI”) 192a, 192b associated with the portable device processors 90a and/or the courier processors 90b. As shown in FIG. 1, the data 150, 152, 154, 156 and the system data may be presented using one or more reports 300.

FIG. 2 schematically illustrates, among other things, various input/output devices 190 (including the GUI 192b, a printer 194, speakers 196, and light emitting diodes 198) associated with the courier database 100 and/or the courier subsystem 94. FIG. 2 also shows a GUI 192a in association with the portable device processors 90a.

The GUI 192a, 192b may include a touchscreen (and the two terms may be used interchangeably herein), a display with or without a “point-and-click” mouse or other input device. The GUI 192a, 192b enables (selective or automatic) display of the data 150, 152, 154, 156 and/or the system data determined by the processors 90—whether received directly therefrom and/or retrieved from the databases 78, 100—as well as display and input, of the certain target parameters and other information associated with the items 20.

The system 50 includes a report generation unit for generating the reports 300. Among others, the following reports 300 may be generated, based upon the reconciled manifest data 156: invoice reports; location reports; software reports; capacity reports; and/or communication reports.

The GUIs 192a, 192b may display the sender item data 150, the courier item data 152, the correction data 154, the manifest data 156, the system data, and/or various alerts. Such alerts may include visual (or audible) warning signals which may be triggered to highlight a given condition to the user 22, for example, if courier capacity is exceeded.

Targets and/or Preferences

The system data are preferably compared, using the processors 90, against predetermined targets, target parameters, and/or preferences for the system data.

Alerts

If the system data is outside of the target parameters, or other than preferred, the processors 90 will generate an alert for presentation to the user 22 and/or the courier 60. The alert is preferably sent to the shipping provider's sender automation department for follow-up.

The processors 90 may also preferably be adapted to analyze the data 150, 152, 154, 156, and alerts may preferably be sent from the portable device subsystem 70 using a Dynamic Mobile Dispatch (“DMD”) system. In this manner, couriers 60 may preferably alert senders and/or recipients, substantially in real-time, of incoming packages 20 and/or delivery times. The system 50 may dispatch upcoming pickups to the courier 60, preferably using a communication tool between the courier dispatcher and the courier 60.

Method

FIGS. 3A to 7 depict steps of a method 400 and a subroutine 500 to reconcile data for use in association with items 20 carried by a courier 60 from a sender and/or sender location to a destination. In the description of the method 400 and subroutine 500 which follow, the same reference numerals are used as those which are used, above, with reference to the system 50 and the portable device 71. Method 400 is suitable for use with the system 50 and portable device 71 described above and shown in FIGS. 3 to 7, but it is not so limited.

As shown in FIG. 3A, the method 400 includes the following steps, among others: a start step; a sender information entry step 402; a sender item data collection step 404; a courier information entry step 406; a courier item data collection step 408; a step 410 of comparing the sender item data against the courier item data; a correction data step 412; a manifest data generation step 414; a report generation step 416; and/or a step 403 of storing the sender item data, the courier item data, the correction data and/or the manifest data in the databases 78, 100.

It will be appreciated that, according to the method 400, the sender item data 150 is collected by the sender facing application 83. The courier item data 152 is collected by the portable device processors 90a. The method 400 preferably involves the initiation of a POP scan. With the preferable use of RFID labels, the scanner 74 of the portable device 71 may read item identification tags 24 at the sender location and create POP records, which may be recorded as courier item data 152 in the portable unit database 78. The processors 90 are used to automatically: compare the sender item data 150 against the courier item data 152 to generate correction data 154; and generate manifest data 156 which includes a combination of the sender item data 150 with the correction data 154. The courier database 100 is regularly updated with the sender item data 150, the courier item data 152, the correction data 154, and the manifest data 156. Thus, according to the invention, the method 400 operatively facilitates cost recovery associated with the items 20 which are delivered by the courier 60.

As shown in FIG. 3B, the sub-method 500 follows the POP scan step 406 and includes the following steps, among others: a system data target entry step 502; a step 504 of determining system data; a step 506 of querying if the system data is outside of the predetermined target parameter for the data. In the event that the query is answered in the affirmative (i.e., if the system data does not meet the predetermined target parameters), the subroutine 500 proceeds to an alert step 508 of alerting the user 22 and then to a step 510 of presenting it to the user 22. If answered in the negative, the sub-method 500 directly proceeds from step 504 to step 510. If applicable, a step 509 of sending a signal to the courier subsystem 94, the portable device subsystem 70 and/or the sender subsystem 80 may also be included in subroutine 500.

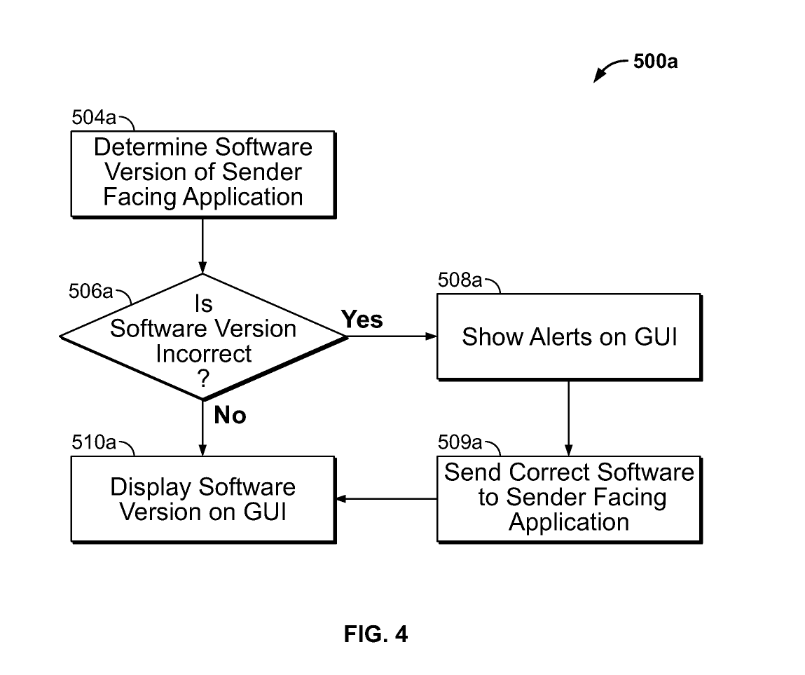

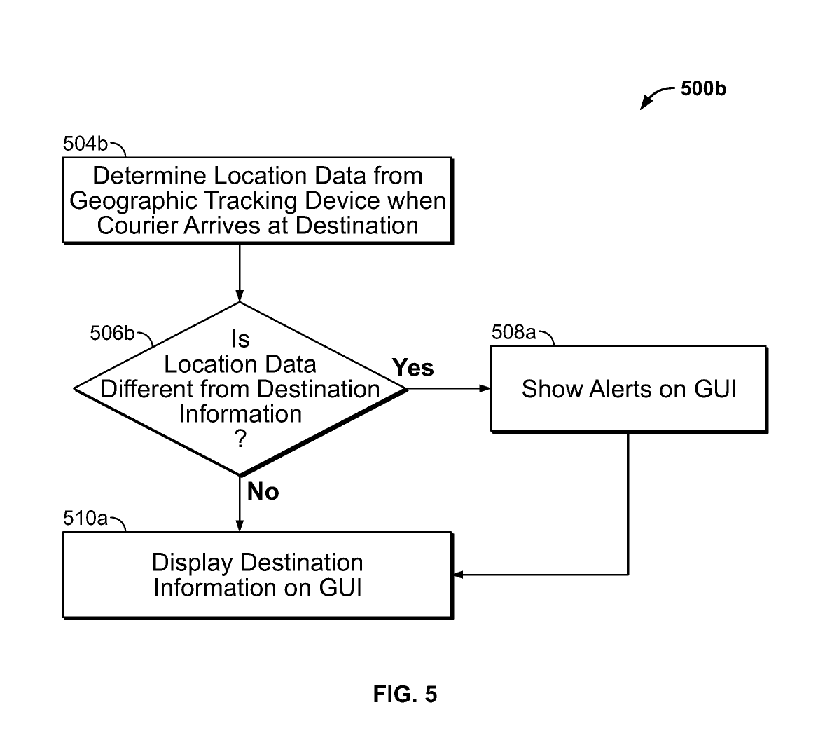

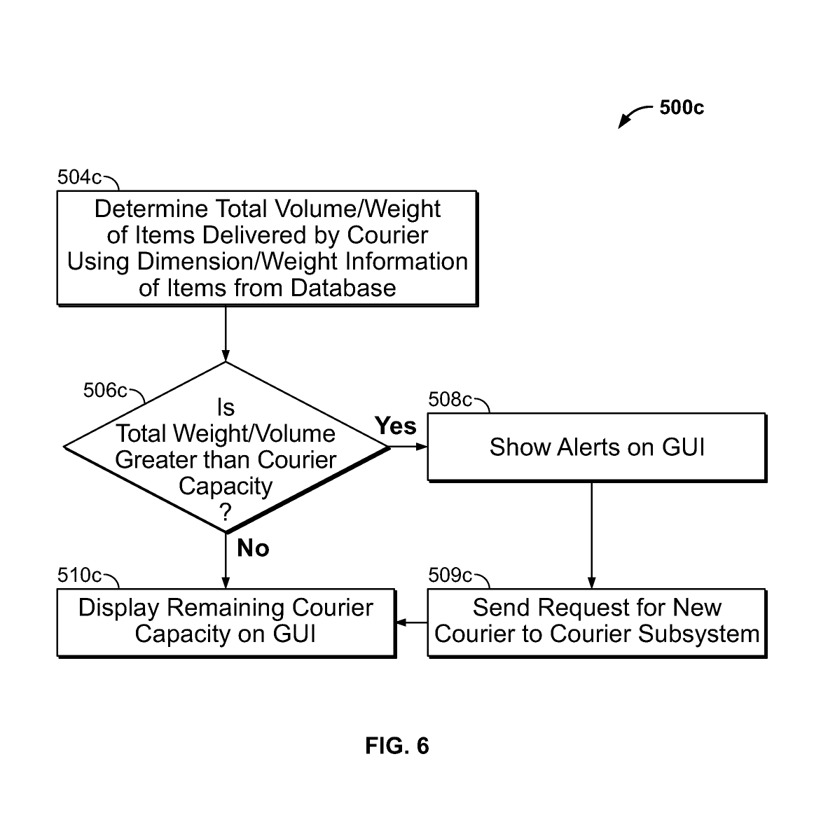

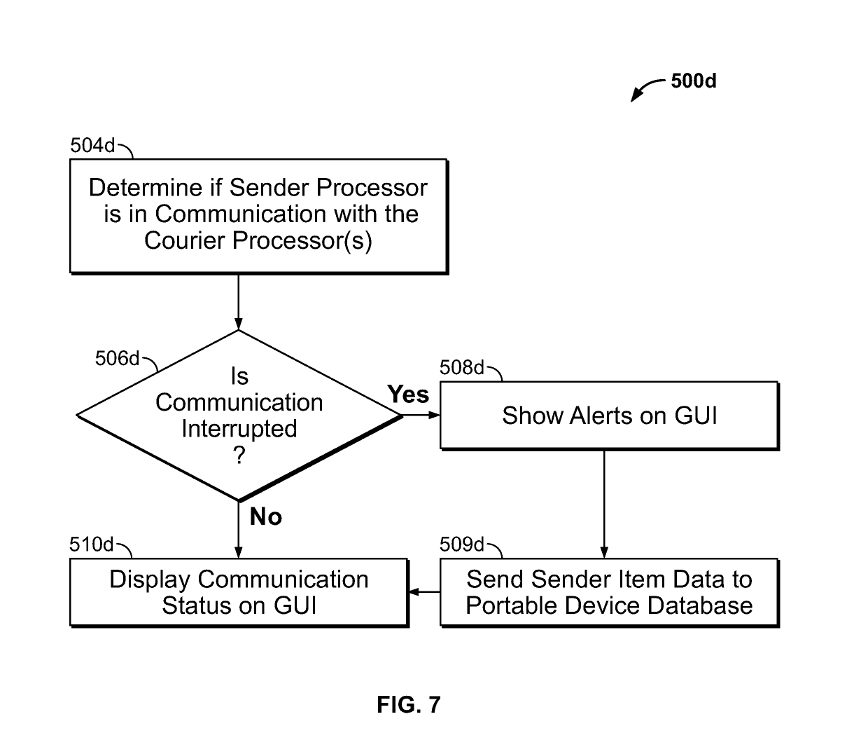

FIGS. 4 to 7 depict certain subroutines 500a, 500b, 500c, and 500d for use with the subroutine 500 in determining the system data, comparing them against the predetermined targets, alerting the user 22 if they fall outside the associated predetermined target parameters, and displaying them to the user 22. More specifically, FIG. 4 depicts a software version subroutine 500a, FIG. 5 depicts a location subroutine 500b, FIG. 6 depicts a courier capacity subroutine 500c, and FIG. 7 depicts a communication link subroutine 500d. It may be appreciated that these subroutines 500a, 500b, 500c and 500d (shown in FIGS. 4 to 7 respectively) may be readily substituted in place of steps 504, 506, 508, 509 and 510 in the subroutine 500 shown in FIG. 3B.

The subroutine 500 preferably signals the courier database 100 and/or the processors 90 if the sender facing application 83 requires a software version 84 update. In the software version subroutine 500a shown in FIG. 4, the processors 90 determine the system data by reading the software version 84a of the sender facing application 83. FIG. 4 shows a software version determination step 504a, a software version comparison query step 506a, the alert step 508a, a software update step 509a and a software version display step 510a.

Preferably, the subroutine 500 may also provide for the capture of latitude and/or longitude information at the destination for comparison against the destination information. Each courier 60 and/or courier transport 62 may have a capturing limitation and/or alerts (e.g., differences between the arrival location and the recorded customer billing data and/or the destination information) may be sent back through the DMD system to the courier database dispatcher to enable pickup. In the location subroutine 500b shown in FIG. 5, the processors 90 determine the system data by reading the location data generated by the geographic tracking device 76. FIG. 5 shows a courier location determination step 504b, a location data and destination information query step 506b, the alert step 508b, and a destination information display step 510b.

Preferably, the subroutine 500 may also determine the volume and/or weight of the items 20 delivered by the courier 60 and/or compile them in an application for subsequent analysis. In the courier capacity subroutine 500c shown in FIG. 6, the processors 90 determine the system data by summing the volume and/or weight of the items 20 from the manifest data 156. The processors 90 compare the sum volume and/or weight to the predetermined courier capacity. FIG. 6 shows a volume and/or weight determination step using the dimensions/weight of the items from the database 504c, a volume and/or weight query step 506c, the alert step 508c, the new courier request step 509c, and the remaining courier capacity display step 510c.

Preferably, a POP scan step and/or an address book function via portable device processors 90a may initiate communication with the sender processors 81—with the portable device processors 90a timing-out after a given time. Alternatively, the courier database 100 and/or courier processors 90b may constantly receive data 150 from the sender processor 81. Upon establishing communication with the sender processors 81, the portable device processors 90a may preferably retrieve sender item data 150 (and/or other data) therefrom for transmission and/or transmit the data 150 to the courier database 100 and/or courier processors 90b. Preferably, the method 400 may be adapted to, based on predetermined rules, designate one or more of the portable device processors 90a as a “master” when multiple couriers 60 attend at a single sender location. Some of the sender item data 150 may be deleted from the sender item data 150, the portable device database 78, and/or the courier database 100 if a parcel 20 is delivered, for example, using a cash on delivery payment method.

Preferably, the method 400 may be useful in all sender item data 150 transmissions and may break reliance on prior art systems (e.g., wireless modem solutions). It may alternately signal an automation specialist via a communication signal to manually retrieve the sender item data 150 from the sender processor 81 and/or sender facing application 83 if the portable device 71 is not able to transport the data 150.

In the communication link subroutine 500d shown in FIG. 7, the processors 90 determine the system data by testing the communication link between the courier processors 90b and the sender processors 81. The processors 90 may preferably, but need not necessarily, test the communication link status by sending a signal to the sender processors 81. FIG. 7 shows a sender processor communication link status determination step 504d, a communication link status query step 506d, the alert step 508d, a portable device database storage step 509d, and a communication link status display step 510d.

Preferably, the method 400 may determine all delivery information from a package 20 as the sender item data 150 is prepared, in keeping with any program the courier 60 may have for visibility and quality control throughout its system 50 (e.g., the method may be adapted to ensure a labeling date is available for over-label).

The method 400 may also preferably include a data packet or “chunk” type application to assist with data transmission in the event of partial and/or intermittent connectivity between the sender processors 81, the portable device processors 90a, and/or the courier processors 90b.

The method may help to evaluate the sender item data 150 and/or the system data at the sender location using a software application that may be provided according to the invention.

Preferably, the method 400 may collect containerization data for the courier transport 62, and apply that data to each of the items 20. Tracking of the containerization data will be applied to each item 20 for the duration that it is carried by the courier transport 62.

Preferably, the method 400 may provide for communication to recipients on incoming packages 20 and/or for other senders or recipients, so when the courier 60 retrieves items 20, the recipient may be notified substantially in real-time by, for example, accessing the system 50 to receive an alert and/or a notification (generated following a POP scan) that items 20 have been picked up by the courier 60 and/or are in transit.

Preferably, a recipient profile may be recorded in the courier database 100 which may be communicated to couriers 60 with instructions and/or directions for how to find a sender and/or destination.

The computer readable medium 160, shown in FIG. 2, stores executable instructions which, upon execution, reconcile data for use in association with items 20 delivered by a courier 60 from a sender and/or a sender location to a destination. The executable instructions include processor instructions 801a, 801b, 802a, 802b, 803a, 803b, 804a, 804b, 805a, 805b, 806a, 806b, 807a, 807b, 808a, 808b, 809a, 809b for the processors 90 to, according to the invention, perform the aforesaid method 400 and subroutine 500 and perform steps and provide functionality as otherwise described above and elsewhere herein. The processors 90 encoded by the computer readable medium 160 are such as to compare the sender item data 150 against the courier item data 152 to generate correction data 154, generate manifest data 156 comprising a combination of the sender item data 150 with the correction data 154, and transmit the data 150, 152, 154, 156 to the courier database 100 and/or the portable device database 78. Thus, according to the invention, the computer readable medium 160 facilitates use of the processors 90 to operatively facilitate cost recovery associated with the items 20 delivered by the courier 60.

Thus, the system 50, method 400, device 71, and computer readable medium 160 operatively facilitate increasing revenue associated with the items 20 which are delivered by the courier 60.

The system 50, method 400, device 71, and computer readable medium 160 are preferably adapted and/or adaptable for use in parcel delivery, postal applications, and supply chain management. In parcel delivery and postal applications, the system 50, method 400, device 71 and computer readable medium 160 are preferably adapted for transport of items 20 to trailers, for transport of parcels, and to improve or facilitate movement of freight. In supply chain management, the system 50, method 400, device 71 and computer readable medium 160 may be employed at each of the numerous global locations and terminals.

This concludes the description of presently preferred embodiments of the invention. The foregoing description has been presented for the purpose of illustration and is not intended to be exhaustive of to limit the invention to the precise form disclosed. Other modifications, variations and alterations are possible in light of the above teaching and will be apparent to those skilled in the art, and may be used in the design and manufacture of other embodiments according to the present invention without departing from the spirit and scope of the invention. It is intended the scope of the invention be limited not by this description but only by the claims forming a part hereof.

What is claimed is:

1. A system for use with items for delivery by a courier from a sender to one or more destinations, wherein the system comprises:
(a) one or more sender processors, local to the sender, operative to execute a sender facing application to collect and transmit sender item data for the items;
(b) at least one portable device, carried by the courier, comprising one or more portable device processors operative to collect and transmit courier item data for the items;
(c) one or more courier processors operative to electronically receive the sender item data from the sender processors and the courier item data from the portable processors, and to automatically generate a manifest, for cost recovery, which comprises a reconciled combination of the sender item data and the courier item data for each of the items; and
(d) a courier database, remote from the sender, to electronically store the manifest;
whereby the system is operative to facilitate cost recovery for the items delivered by the courier.

2. A system according to claim Error! Reference source not found., wherein the portable device further comprises a scanner operative to read, for each one of the items, a unique identification tag associated with said each one, so as to collect the courier item data.

3. A system according to claim Error! Reference source not found., wherein the reconciled combination of the sender item data and the courier item data, for each of the items, comprises dimension data, weight data, destination data, special handling data if any, and/or special services data if any.

4. A system according to claim Error! Reference source not found., wherein if transmission of the sender item data is temporarily interrupted, the sender processors are operative to transmit and the courier processors are adapted to receive the sender item data as a plurality of discrete data packets for subsequent automatic assembly and generation of the manifest by the courier processors as aforesaid.

5. A system according to claim Error! Reference source not found., wherein if transmission of the courier item data is temporarily interrupted, the portable device processors are operative to transmit and the courier processors are adapted to receive the courier item data as a plurality of discrete data packets for subsequent automatic assembly and generation of the manifest by the courier processors as aforesaid.

6. A system according to claim Error! Reference source not found., further comprising a geographic tracking device operative to obtain location data of the courier from a geographic information system and to automatically associate the location data with each of the items being delivered by the courier.

7. A system according to claim Error! Reference source not found., wherein the portable device processors and/or the courier processors are operative (i) to automatically determine the location data when each one of the items is delivered by the courier, and (ii) if the location data differs from destination data for said each one, to automatically generate an alert for presentation to a user of the system.

8. A system according to claim Error! Reference source not found., wherein the portable device processors and/or the courier processors are operative (i) to automatically determine if the sender facing application requires updating, and (ii) in such event, to automatically update the sender facing application.

9. A system according to claim Error! Reference source not found., wherein the portable device processors and/or the courier processors are operative (i) to automatically determine remaining capacity data for the courier, using dimension data to calculate volume data for each of the items for delivery by the courier and summing together the volume data and (ii) if the remaining capacity data is lower than a predetermined target therefore, to automatically generate an alert for presentation to a user of the system.

10. A system according to claim Error! Reference source not found., wherein (i) the sender processors and/or the courier processors are operative to automatically determine if communication between the sender processors and the courier processors is interrupted, and (ii) in such event, the sender processors automatically transmit the sender item data to the portable device and, subsequently, the courier processors automatically receive the sender item data from the portable device processors.

11. A system according to claim Error! Reference source not found., wherein the courier processors are operative to electronically receive the sender item data and the courier item data via the courier database.

12. A system according to claim Error! Reference source not found., wherein the courier database electronically stores one or more updated versions of the manifest, the sender item data and/or the courier item data at least once a day.

13. A system according to claim Error! Reference source not found., wherein the courier processors are located remotely from the sender; and/or the courier database is located remotely from the portable device and/or the sender.

14. A system according to claim Error! Reference source not found., wherein the portable device further comprises a portable device database which is located remotely from the courier database, and which stores one or more versions of the manifest, the sender item data and/or the courier item data that are stored in the courier database.

15. A method for use in association with the delivery of items by a courier from a sender to one or more destinations, wherein the method comprises the steps of:
(a) operating one or more sender processors, local to the sender, to execute a sender facing application to collect and transmit sender item data for the items;
(b) operating one or more portable device processors of at least one portable device, carried by the courier, to collect and transmit courier item data for the items;
(c) operating one or more courier processors to electronically receive the sender item data from the sender processors and the courier item data from the portable device processors, and to automatically generate a manifest, for cost recovery, which comprises a reconciled combination of the sender item data and the courier item data for each of the items; and
(d) electronically storing the manifest in a courier database remote from the sender;
whereby the method operatively facilitates cost recovery for the items delivered by the courier.

16. A method according to claim Error! Reference source not found., wherein in step (b), a scanner of the portable device is operated to read, for each of the items, a unique identification tag associated with said each one, so as to collect the courier item data.

17. A method according to claim Error! Reference source not found., wherein in step (c), the reconciled combination of the sender item data and the courier item data, for each of the items, comprises dimension data, weight data, destination data, special handling data if any, and/or special services data if any.

18. A method according to claim Error! Reference source not found., wherein if transmission of the sender item data is temporarily interrupted, the sender processors are operative in step (a) to transmit the courier processors are adapted in step (c) to receive the sender item data as a plurality of discrete data packets for subsequent automatic assembly and generation of the manifest by the courier processors as aforesaid.

19. A method according to claim Error! Reference source not found., wherein if transmission of the courier item data is temporarily interrupted, the portable device processors are operative in step (b) to transmit and the courier processors are adapted in step (c) to receive the courier item data as a plurality of discrete data packets for subsequent automatic assembly and generation of the manifest by the courier processors as aforesaid.

20. A method according to claim Error! Reference source not found., further comprising a step of operating a geographic tracking device to obtain location data for the courier from a geographic information system and to automatically associate the location data with each of the items being delivered by the courier.

21. A method according to claim Error! Reference source not found., wherein in step (b) the portable device processors and/or in step (c) the courier processors are operative (i) to automatically determine the location data when each one of the items is delivered by the courier, and (ii) if the location data differs from destination data for said each one, to automatically generate an alert for presentation to a user of the system.

22. A method according to claim Error! Reference source not found., wherein in step (b) the portable device processors and/or in step (c) the courier processors are operative (i) to automatically determine if the sender facing application requires updating, and (ii) in such event, to automatically update the sender facing application.

23. A method according to claim Error! Reference source not found., wherein in step (b) the portable device processors and/or in step (c) the courier processors are operative (i) to automatically determine remaining capacity data for the courier, using dimension data to calculate volume data for each of the items for delivery by the courier and summing together the volume data, and (ii) if the remaining capacity data is lower than a predetermined target therefor, to automatically generate an alert for presentation to a user of the system.

24. A method according to claim Error! Reference source not found., further comprising the steps of (i) operating the sender processors in step (a) and/or the courier processors in step (c) to automatically determine if communication between the sender processors and the courier processors is interrupted, and (ii) in such event, operating the sender processors in step (a) to automatically transmit the sender item data to the portable device and, subsequently, operating the courier processors in step (c) to automatically receive the sender item data from the portable device processors.

25. A method according to claim Error! Reference source not found., wherein in step (c) the courier processors are operative to electronically receive the sender item data and the courier item data via the courier database.

26. A method according to claim Error! Reference source not found., wherein in step (d), the courier database electronically stores one or more updated versions of the manifest, the sender item data and/or the courier item data at least once a day.

27. A method according to claim Error! Reference source not found., wherein in step (c), the courier processors are located remotely from the portable device and/or the sender, and/or wherein in step (d) the courier database is located remotely from the portable device.

28. A method according to claim Error! Reference source not found., further comprising a step of storing, in a portable device database of the portable device which is remote from the courier database, one or more versions of the manifest, the sender item data and/or the courier item data that are stored in the courier database.

29. A portable device, carried by a courier, for use with a sender processor local to a sender executing a sender facing application which collects and transmits sender item data for items to be delivered to one or more destinations, for use with a courier processor which electronically receives the sender item data from the sender processors, and for use with a courier database remote from the sender, wherein the portable device comprises:
(a) a scanner operative to read, for each one of the items, a unique identification tag associated with said each one, so as to collect courier item data; and
(b) one or more portable device processors operative to collect the courier item data from the scanner and electronically transmit the courier item data to the courier processor for automatic generation of a manifest, for cost recovery, which comprises a reconciled combination of the sender item data and the courier item data for each of the items, with the manifest electronically stored in the courier database;
whereby the portable device is operative to facilitate cost recovery for the items delivered by the courier.

30. A portable device according to claim Error! Reference source not found., wherein if transmission of the courier item data is temporarily interrupted, the portable device processors are operative to transmit the courier item data to the courier processors as a plurality of discrete data packets for subsequent automatic assembly and generation of the manifest by the courier processors as aforesaid.

31. A portable device according to claim Error! Reference source not found., wherein if communication between the sender processors and the courier processors is interrupted, the portable device processors are further adapted to automatically receive the sender item data from the sender processors and subsequently automatically transmit the sender item data to the courier processors.

32. A portable device according to claim Error! Reference source not found., further comprising a geographic tracking device operative to obtain location data of the courier from a geographic information system and to automatically associate the location data with each of the items being delivered by the courier, and wherein the portable device processors are operative to collect and electronically transmit the location item data to the courier processor.

33. A portable device according to claim Error! Reference source not found., wherein the portable device processors are operative to have the geographic tracking device automatically determine the location data when each one of the items is delivered by the courier.

34. A portable device according to claim Error! Reference source not found., wherein the portable device processors are operative to automatically determine if the sender facing application requires updating, and/or to automatically update the sender facing application.

35. A portable device according to claim Error! Reference source not found., wherein the portable device processors are operative to automatically determine remaining capacity data for the courier, using dimension data to calculate volume data for each of the items for delivery by the courier and summing together the volume data.

36. A portable device according to claim Error! Reference source not found., wherein, if communication between the sender processors and the courier processors is interrupted, the portable device is operative to automatically receive the sender item data from the sender processors and, subsequently, to automatically transmit the sender item data to the courier processors.

37. A portable device according to claim Error! Reference source not found., further comprising a portable device database which stores one or more versions of the manifest, the sender item data and/or the courier item data.

38. A computer readable medium on which is physically stored executable instructions which, upon execution, will generate a manifest for cost recovery; for use in association with the delivery of items by a courier from a sender to one or more destinations; wherein the executable instructions comprise processor instructions for one or more sender processors local to the sender, portable device processors of at least one portable device carried by the courier, and/or courier processors to automatically:
(a) collect and/or electronically communicate sender item data for the items from the sender processors to the courier processors;
(b) collect and/or electronically communicate courier item data for the items from the portable device processors to the courier processors;
(c) automatically generate the manifest which comprises a reconciled combination of the sender item data and the courier item data for each of the items; and
(d) electronically store the manifest in a courier database remote from the sender;
to thus operatively facilitate cost recovery for the items delivered by the courier.
